(19) United States
(12) Patent Application Publication
(10) Pub. No.: US 2006/0265327 A1
(43) Pub. Date: Nov. 23, 2006

(54) Sales completion system for mobile devices that supports invoice display and approval

(76) Inventors: Bindu Rama Rao, Laguna Niguel, CA (US); Glenn Hamasaki JR., Aliso Viejo, CA (US)

Correspondence Address: Bindu Rama Rao, 21 Henley Drive, Laguna Niguel, CA, 92677, US

(21) Appl. No.: 11/195,262

(22) Filed: Aug. 1, 2005

Related U.S. Application Data
(63) Continuation-in-part of application No. 11/130,751, filed on May 17, 2005.

(51) Int. Cl. G06Q 40/00

(52) U.S. Cl. 705/40

(57) ABSTRACT

A sale completion network comprising a mobile device communicatively coupled to a carrier network to which a third remote sales management server 133 may also be communicatively coupled. The mobile device is communicatively coupled with a remote phone, such as a cellular phone, a landline phone, a voice-over IP phone etc. The mobile device comprises a sales completion client, a user profile and a security component. The mobile device may be adapted to access the remote sales management servers to receive an invoice from it, or a reference (such as a URL) to an invoice. The mobile device can retrieve a sales invoice using the reference (such as URL, or an invoice id) and other related information, display them for review and approval by a customer, and conduct sales related transactions after user review and/or approval.

### RELATED APPLICATIONS

The present application is a continuation-in-part of the U.S. patent application Ser. No. 11/130,751, entitled “SYSTEM AND METHOD FOR MANAGING SALES COMPLETION ON MOBILE DEVICES” (Attorney Docket No. GH2004US02), filed May 17, 2005, which is a conversion of the provisional application titled “SYSTEM AND METHOD FOR MANAGING SALES COMPLETION ON MOBILE DEVICES”, filed May 17, 2004. The complete subject matter of both of these patent applications is hereby incorporated herein by reference, in their entirety.

### FEDERALLY SPONSORED RESEARCH OR DEVELOPMENT

Not Applicable

### MICROFICHE/COPYRIGHT REFERENCE

Not Applicable

### BACKGROUND OF THE INVENTION

Quite often people purchase products from a vendor by calling the vendor on the phone, such as a mobile phone or PDA, inquiring about the items they are interested in buying, and pay for their purchases using a credit card. However, this process leaves room for error and fraud. For example, the vendor may charge the customer on the phone in error, or overcharge the customer. The customer does not typically realize that they are overcharged or that a fraud has been committed until they review their monthly credit card statements. Another problem occurs when the customer does not understand the salesman correctly or does not properly hear the sales price quoted to him. Thus, the actual price paid by the customer, using his credit or debit card, may come as a surprise to the customer much later, when the customer reviews a monthly statement from the credit card company or bank. The customer may then try to cancel the transactions. Thus, the customer is likely to be dissatisfied by the experience and the sales person/merchant is likely to be put into financial loss due to such transactions.

Electronic devices, such as mobile phones and personal digital assistants (PDA's), often are used to initiate and purchase mobile content and services. For example, a user may employ his mobile device to purchase and download software.

For various reasons, after the initiation of a mobile transaction the user may not complete the mobile transaction. Currently, there are no automated mechanisms that can notify the network of the failed attempt or assist a user to complete this interrupted transaction. A user who cannot successfully complete a sales transaction using a mobile device will be reluctant to attempt the same or similar transaction again.

The growth of wireless applications and services are skyrocketing. Unfortunately, the growth of these applications and services is mirrored by increased complexity of the mobile devices. This complexity is serving as a deterrent for wide spread adoption of next generation applications and services severely reducing the market opportunity.

### BRIEF SUMMARY OF THE INVENTION

A method and/or device supporting firmware update using an update agent in a mobile device, substantially as shown in and/or described in connection with at least one of the figures, as set forth more completely in the claims;

FIG. 2 is an interaction diagram that shows exemplary interactions and information flow between the various entities in the sales completion network;

FIG. 3 is an interaction diagram that shows another exemplary interactions and information flow between the various entities in the sales completion network; and

FIG. 4 is a flow chart of an exemplary operation of the sales completion client in the sales completion phone.

### BRIEF DESCRIPTION OF SEVERAL VIEWS OF THE DRAWINGS

FIG. 1 is a perspective diagram of a sale completion network comprising a mobile device communicatively coupled to a carrier network to which an third remote sales management server may also be communicatively coupled; and

FIG. 2 is a perspective block diagram of an embodiment of the present invention wherein USB based removable flash memory storage devices comprise of both a USB male adapter as well as a USB female adapter such that two such units could be plugged into each other for transferring data from one to the other.

### DETAILED DESCRIPTION OF THE INVENTION

Aspects of the present invention relate generally to the process of conducting sales over a phone, such as a mobile device, and more specifically, to the use of a sales completion client to facilitate display of an invoice and approval by the customer for the sales event. The following discussion makes reference to the term “electronic device” that is used herein to refer to mobile electronic devices such as, for example, a mobile handset, a cellular phone, a personal digital assistant (PDA), a pager, and a personal computer, to name just a few. Although the listed example electronic devices are mobile devices, application of the present invention is not limited in this manner, as representative embodiments of the present invention may be employed in a wide variety of electronic devices, both fixed and mobile.

Electronic devices may be adapted to access sales servers to receive an invoice or a reference (such as a URL) to an invoice. These electronic devices can retrieve sales invoices and other related information, display them for review by a customer, and conduct sales related transactions. An electronic device may be, for example, a mobile electronic device having sales software such as mobile cellular phone handsets, personal digital assistants (PDAs), pagers, MP-3 players, digital cameras, etc.

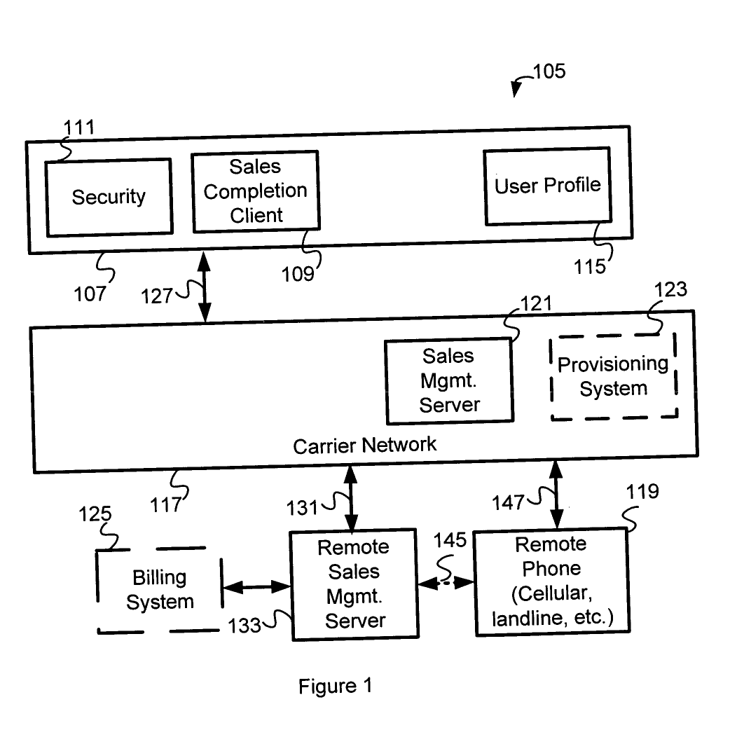

FIG. 1 is a perspective diagram of a sale completion network 105 comprising a mobile device 107 communicatively coupled to a carrier network 117 to which an third remote sales management server 133 may also be communicatively coupled. The mobile device 107 is communicatively coupled with a remote phone 119, such as a cellular phone, a landline phone, a voice-over IP phone etc. The mobile device 107 comprises a sales completion client 109, a user profile 115 and a security component 111.

The mobile device 107 may be adapted to access the remote sales management servers 133 to receive an invoice from it, or a reference (such as a URL) to an invoice. The mobile device 107 can retrieve a sales invoice using the reference (such as URL, or an invoice id) and other related information, display them for review and approval by a customer, and conduct sales related transactions after user review and/or approval.

The mobile device 107 facilitates a sales call by a user, with a remote sales person using the remote phone 119, wherein the user is presented with a sales invoice communicated by the remote sales person via the remote sales management server 131. The user has the option to review an invoice or a sales receipt presented by the remote sales person (using the remote phone), when the mobile device 107 displays the invoice or a sales receipt that is transferred by the remote sales management server during an online sales event.

The user typically dials the remote sales person using the mobile device 107 (or, as in a related embodiment, a landline phone) and dialing the phone number of the remote phone. After determining the availability of one of more products (or services), the user places an order for those products. The remote sales person then causes the remote sales management server 133 to communicate an invoice based on the products selected for purchase by the user. The user reviews the presented invoice, that is displayed by the mobile device 107, with a prompt to the user to review it and/approve it. The user reviews the invoice presented, and, if it looks all right, approves the invoice. The approval of the invoice is communicated by the mobile device to the remote sales management server 133. In one embodiment, a user profile 115, comprising of at least one of a credit card information (an account identification, an expiry date, a security code, a credit limit etc.), a shipping address, a billing address and a subscription information, is communicated to the remote sales management server 133 along with the approval from the user. In another embodiment, the user profile 115 is communicated along with the approval of an invoice or receipt presented, only if the remote sales management server 133 requests the user profile 115. In yet another embodiment, the user approval is not solicited but a user profile 115 is solicited by the remote sales management server 133 from the user of the mobile device 107 using appropriate prompts and messages. In response, if the user approves delivery of the user profile, it is communicated to the remote sales management server 133 by the sales completion client 109 of the mobile device 107.

In one embodiment, when a user approves of an invoice or sales receipt presented by the remote sales management server 133, the approval is provided along with a digitally signed content, wherein the digital signature facilitates non-repudiation (of the approval) by the user. The digital signature is created using the invoice received and cryptographic means provides by a security module 111 of the mobile device 107. In one embodiment, the security module 111 is provided by a SIM or SmartCard used by the mobile device 107. In another embodiment, the security module 111 is provided by a memory stick or removable memory unit plugged into the mobile device 107.

The carrier network 117 comprises a sales management server 121, an optional promotion server 119, and an optional provisioning system 123. The carrier network's sales management server 121 is used by the remote phone 119 to communicate the invoice to the mobile device. In one embodiment, the provisioning system 123 provisions a sales related user profile 115 for the mobile device 107. It sales provisions the cryptographic key or keys for the security module 111. In a related embodiment, where the security module 111 is part of a SIM or SmartCard, the provisioning system 123 provisions cryptographic keys and other related information into the SIM/SmartCard. 111.

In general, the sales completion client 109 receives invoices and sales receipts and displays them so as to let the user review it and approve it, if necessary. If user approval is needed, the user approval is solicited, and the user response to communicated by the sales completion client 109 to the sales server. The security module 111 provides support for various levels of security for user sales transactions. For example, in one embodiment, the user approval is digitally signed by the security module 111 such that the remote sales management server 133 or the sales management server 121 of the carrier network 117 can verify it. Thus, then security module 111 facilitates non-repudiation of user sales transaction. It also supports authentication of the remote sales management server 133 or the sales management server 121. In one embodiment, the security model 111 is one of a SIM card or a SmartCard.

The sales completion client 109 architecture is such as to support storage of invoices, deferred approval of stored invoices, automatic delivery of user profile 115 with approval of sales transactions, modification of the user profile 115, etc. Support for primary user profile and secondary user profiles is an additional feature.

In one embodiment, a generic sales completion client 109 is used by the carrier network/operator 117 (such as Sprint in Sprint network or Cox in Cox cable network) to support invoice display and approval of invoices and sales receipts presented by a sales person, such as those working at a departmental store or mail-order sales companies.

In one embodiment, the sales completion client 109 is a downloadable program that can be installed on the mobile device 107. In a related embodiment, it is a java application.

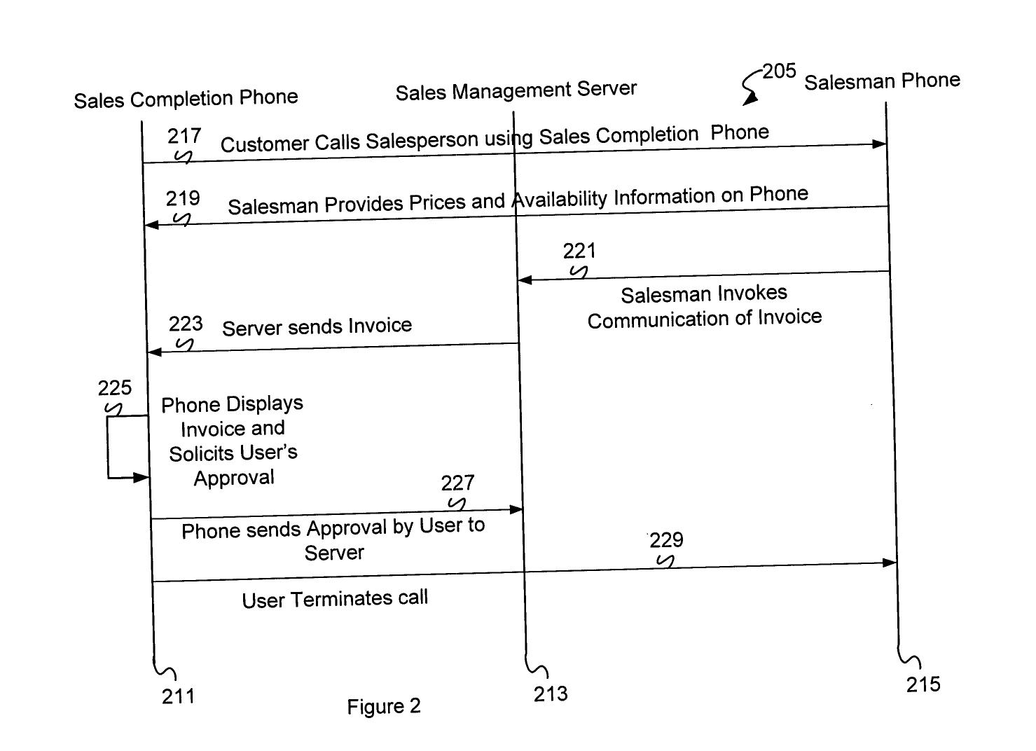

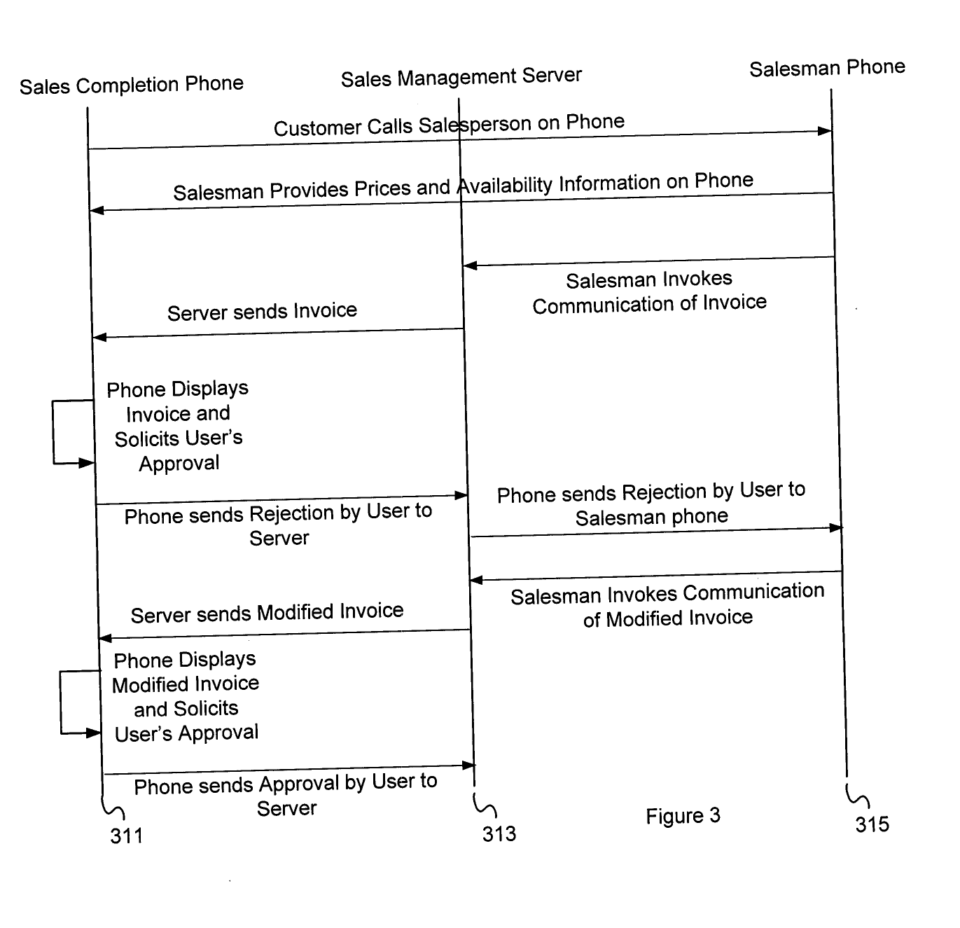

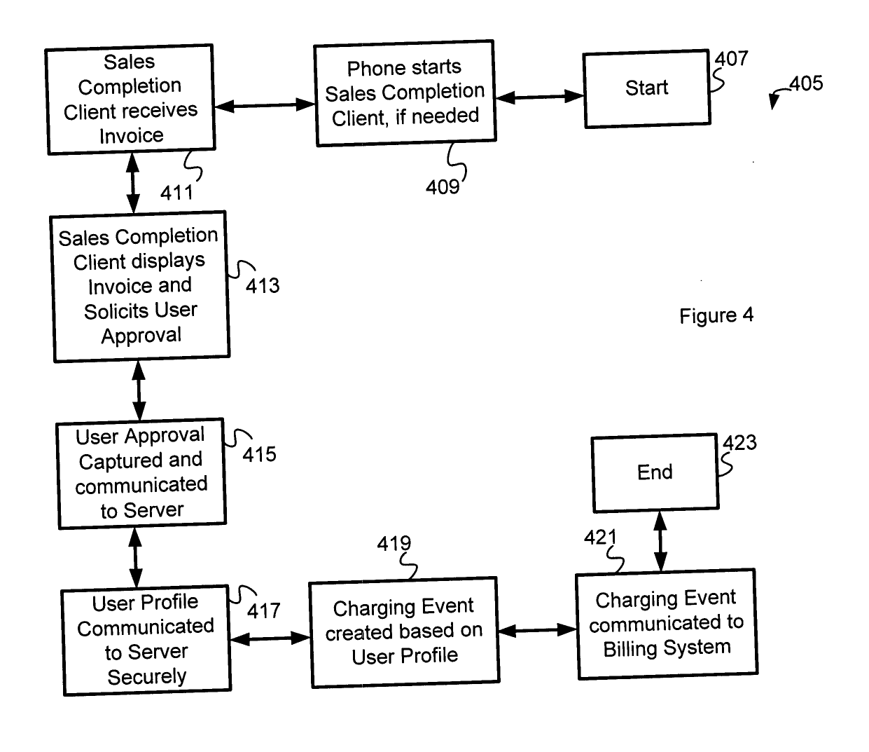

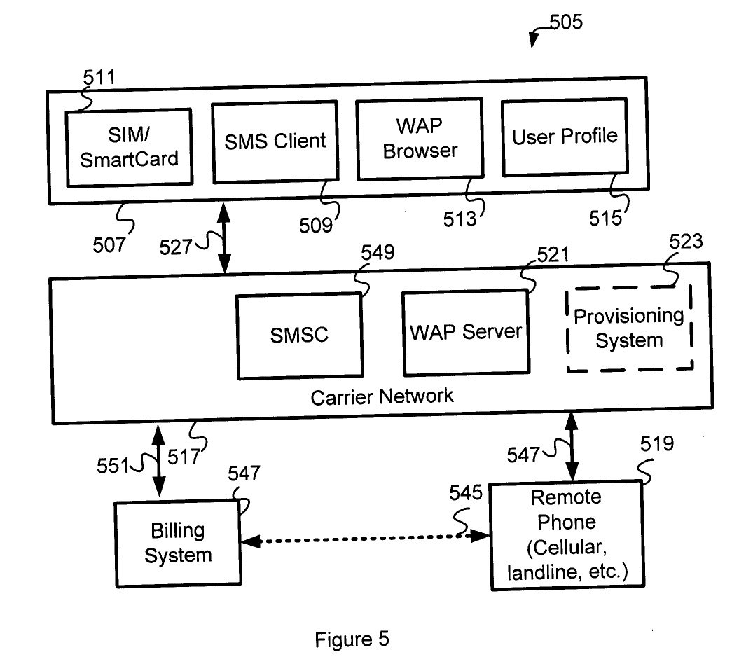

FIG. 2 is an interaction diagram that shows exemplary interactions and information flow between the various entities in the sales completion network. The sales completion phone 211 is used by the customer (user) to call the salesman on his salesman phone 215. The sales completion phone comprises a sales completion client capable of receiving an invoice or sales receipt and displaying it. It is also capable of soliciting user approval and communicating the user approval. It is also capable of communicating a user profile.

The customer may inquire about the prices and availability of one or more products or services. The salesman provides the requested prices and availability information on the phone. The interactions 217 and 219 are conducted using voice channels. They may be conducted over data channels too, or using voice-over IP connections. When the customer and the salesman have come to an understanding, the salesman invokes communication of the invoice to the user, by means of transfer of an invoice via the sales management server 213 to the sales completion client 211 in the sales completion phone, such as a mobile device.

When invoked by the salesman, the sales management server 213 creates an invoice, if necessary, and communicates it to the sales completion client in the sales completion phone 211 (a mobile device, a PDA, a landline phone, a VOIP phone, etc.). In one embodiment, the sales management server 213 transfers an invoice to the sales completion client in the sales completion phone 211, for display and for soliciting user approval. In another embodiment, it sends a notification to the sales completion client that is received, processed and optionally displayed by the sales completion client. The sales completion client then contacts the sales management server to retrieve an invoice, using information provided in the notification.

When the sales completion phone receives the invoice, it displays it and solicits user's approval. When the sales completion client receives the user approval, it sends it to the sales management server 213. At this point, the sales transaction is complete. The sales management server 213 may also receive a user profile from the sales completion phone. The sales management server 213 may also retrieve a user profile from the sales completion phone if one is not provided to it by default. The user profile may comprise of a credit card information, shipping address, billing address, etc. The user approval received may be digitally signed by the sales completion phone 211. The sales management server may optionally communicate a transaction completion message to the salesman using the salesman phone. Finally, the user may terminate the call from the sales completion phone or the salesman may terminate the call from the salesman phone.

FIG. 3 is an interaction diagram that shows another exemplary interactions and information flow between the various entities in the sales completion network. The sales completion phone 311 is used by the customer (user) to call the salesman on his salesman phone 315. This interaction is similar to the one described for FIG. 2 and depicts a scenario where the user rejects the sales transaction initially, such as due to a wrong invoice being displayed or inaccurate pricing on the invoice. The sales completion phone 311 sends a message indicating the user's rejection to the sales management server 313, which, in response, sends the message indicating rejection by user to the salesman phone. In a related embodiment, the rejected invoice is displayed by the salesman phone for the salesman to review.

The salesman on the salesman phone 315 invokes the communication of a modified invoice, to the sales completion phone 311. The sales management server 313 then sends the modified invoice to the sales completion phone for display and solicitation of the customer's approval. The customer's (user's) approval is received by the sales management server 313, which optionally communicates it to the salesman's phone 315. The sales transaction may be terminated and the call terminated by either the salesman phone 315 or the sales completion phone 311.

In one embodiment, the invoice is communicated to the sales completion client by the sales management server using an SMS transport. In another embodiment, it is communicated over an data service, such as a GPRS service.

FIG. 4 is a flow chart of an exemplary operation of the sales completion client in the sales completion phone. At a start block 407, the processing of the sales completion client starts, when the sales completion phone is used by the user to talk with a sales person. Then, at a next block 409, the sales completion phone starts the sales completion client, if necessary. For example, if the sales management server wants to communicate an invoice to the sales completion phone, it needs to communicate with the sales completion client, and either the user can start the sales completion client (such as invoking an application) or the sales completion client is automatically started when the invoice, or a notification message containing an invoice, etc. are received by the sales completion phone from the sales management server. The sales management server employs an SMS or a GPRS connection (or some such bearer) to send the invoice. In a related embodiment, based on device capabilities, the sales management server employs the right bearer for sending the invoice.

Then, at a next block 411, the sales completion client receives the invoice. Then, at a next block 413, the sales completion client displays the invoice and solicits user approval. The response from the user is typically communicated to the sales management server at the next block 415. In addition, the user profile is optionally communicated to the sales management server at the next block 417. In general, such user profile communication is conducted securely. For example, a secure transport such as SSL or TLS may be employed. Alternatively, using an appropriate security module in the sales completion client, the user profile is encrypted and sent to the sales management server. For non-repudiation or for authentication by the sales management server, a digital signature of the user profile is also sent.

Then, at a next bock 419, a charging event is created, based on the user profile is optionally communicated. The charging event comprises all relevant sales transaction information, such as an invoice number or a receipt number, a time stamp, subset's of information from the user profile, etc.

Then, at the next block 421, the charging event is communicated to a billing system. This billing system may be associated with the operator network or with the sales management server. Finally, the processing terminates at an end block 423.

Although the creation of the charging event and the communication of the charging event is described as being conducted by the sales completion client, in one embodiment, they are conducted by the sales management server.

Typically, in accordance with the present invention, the phone supports online purchase of products by a customer, and makes it possible to review an invoice before the online sale is completed or successfully terminated. The phone comprises a voice connection circuitry to connect with a second phone used by a remote merchant, a data communication circuitry to connect to a remote merchant server and receive an invoice and a display circuitry to display the invoice. It also comprises an input means to receive a user approval of the displayed invoice. The phone displays the invoice when it receives one, then solicits user approval, and subsequently communicates the user approval to the remote merchant server when a user responds using the input means.

FIG. 5 is a perspective diagram of an exemplary embodiment of the sales network 505 wherein a billing system 547 communicates a sales receipt or an invoice to a mobile device 507 when the customer of the remote phone 519 initiates the communication of the sales receipt or invoice to the customer currently using the mobile device 507. The customer employs the mobile device 507 to interact, using a voice communication facility provided by a carrier network 517, with the sales person or merchant currently using remote phone 519. After selecting one or more items (products, services, etc.) for purchasing, the customer requests the sales person or merchant to send an invoice or sales receipt for review and approval. The sales person or merchant then interacts with the billing system 547, either directly or using the remote phone 519, to create a sales receipt or an invoice based on the items purchased by the customer. The sales person or merchant then causes the billing system 547 to communicate the invoice to the mobile device 507. After an approval is received from the mobile device 507 by the billing system 547, the sales transaction is completed and the voice communication link between the mobile device 507 and the remote phone 519 is terminated.

In one embodiment, the sales person provides the customer with a code that the customer uses to validate the sales information, such as an invoice or a sales receipt, communicated by the billing system 547 or the remote phone 519. The customer is prompted for the code when a notification message is received by the mobile device 507. After the code is provided by the customer, it is used to selectively validate the notification message and/or the sales information received.

The mobile device 507 comprises a SIM/Smartcard 511, an SMS client 509, a WAP Browser 513 and a user profile 515. The SMS client is used to receive SMS messages sent by the billing system 547. Such an SMS message may comprise of an invoice or sales receipt, and may be delivered as a multi-part message. In addition, the customer is prompted to review the invoice or sales receipt

In one embodiment, the billing system 547 communicates an invoice or sales receipt to the WAP browser 513, via the carrier network 517, for display to the customer and review and approval by the customer, the approval being communicated back to the billing system 547 by the WAP browser 513 to complete the sales transaction successfully. Specifically, the billing system 547 communicates an invoice or sales receipt to the WAP server 521 over a secure transport, such as SSL or TLS, which in turn communicates the invoice or sales receipt to the WAP browser 513 of the mobile device 507 using a secure transport such as WTLS. The customer can then review the invoice or sales receipt and then provide an approval, which is communicated back to the billing system 547 by the WAP browser via the WAP server 521.

In one embodiment, the billing system 547 communicates a reference to an invoice or sales receipt, such as an URL, to the SMS client 509 (or some alternative notification client). A prompt to the customer is also sent along with it soliciting customer review and approval. While reviewing the SMS message received, that is displayed by the SMS client 509, the customer is provided with the option to retrieve the sales receipt or invoice using the URL provided. If the customer chooses to do so, the WAP browser 513 retrieves the invoice or sales receipt, via the WAP server 521. The URL typically provides a reference to the invoice or sales receipt statically stored (or assembled when required) at the billing system 547, or an alternative web site).

In one embodiment, when the customer using the mobile device 507 and the sales person or merchant using the remote phone 519 come to an agreement on the items being purchased and the price for it, the sales person or merchant using the remote phone 519 causes the billing system 547 to send an SMS message based notification, via the SMSC 549 to the SMS client 509, along with the URL of an invoice or a sales receipt created and stored in the billing system 547 or an alternative website. The notification comprises the merchant identification, a time stamp, a total cost or purchases, the tax for the purchases, the shipping cost, etc. The SMS client displays the notification for the customer. In addition, it optionally saves it in the mobile device 507, such as in a small database of sales notifications. The SMS client makes it possible for the user to browse the invoice or sales receipt whose reference is provided in the notification, such as by means of the WAP browser 513 (or other HTML or XML based browsers). The customer approval is solicited by the invoice or sales receipt displayed by the WAP browser 513. If the customer approves it, the approval, along with an optional digital signature for security purposes, is sent to the billing system 547.

In a related embodiment, the invoice or sales receipt is sent to, and displayed by the SMS client 509. In addition, user approval is communicated to the billing system 547, by means of a mobile device initiated SMS messaging service provided by the SMS client 509.

In general, the WAP browser 513, is capable of displaying invoices or sales receipt retrieved via the carrier network 517, for display to the customer and review and approval by the customer, the approval being communicated back to the billing system 547 by the WAP browser 513 to complete the sales transaction successfully.

In one embodiment, an invoice sent to the customer by the billing system 547 is to be approved by the user before the sales transaction is completed. However, payment (or money transfer by the customer) occurs subsequently, when the customer sends a check to the merchant or makes a payment by some alternative means. On the other hand, if a sales receipt is communicated to the customer, the user approval initiates an immediate transfer of money based on credit card accounts, debit card accounts or other bank accounts.

In one related embodiment, the billing system 547 is a sales computer used by the merchant or sales person using the remote phone 519 to create invoices, sales receipt and other related information that are sent to the mobile device via the carrier network 517, or that is retrieved by the mobile device 507 via the carrier network 517.

In one embodiment, the sales receipt comprises a timestamp, a total amount and a merchant identification. In another embodiment, it also comprises the list of items being purchased by the user of the mobile device, such as the mobile device 107 or 507.

In general, a method of conducting a sales transaction over a first phone connection, such as a voice connection, established between a customer phone 107 and a salesman phone 119 comprises several steps or activities, such as collecting a sales information on at least one product selected by a customer, communicating at least one of an invoice and a sales receipt, based on the collected information, by a sales management server 121 or 133 to the customer phone and receiving the at least one of an invoice and a sales receipt by the customer phone from the sales management server. It also comprises displaying the at least one of an invoice and a sales receipt by the customer phone, soliciting customer approval for the at least one of an invoice and a sales receipt by the customer phone 107 and communicating a customer response received to a sales management server 121 or 133 by the customer phone 107. In addition, collecting the sales information comprises entering, via a sales user interface associated with the sales management server, the sales information into the sales management server 121 or 133 and storing the sales information.

The customer response is one of an approval and a rejection. Again, communicating comprises creating at least one of an invoice and a sales receipt based on the sales information and establishing a second phone connection with the customer phone 107. The activity of communicating also comprises transferring the at least one of an invoice and sales receipt to the customer phone 107 over the second phone connection.

In a related embodiment, the first phone connection is a voice connection and the second phone connection is one of a SMS connection, a data connection, a data connection over GPRS, a data connection over VOIP, a data connection over EDGE, a data connection over WiFi, a data connection over WiMAX or a data connection over WAP.

In another embodiment of the present invention, the method of conducting a sales transaction using a customer phone 107 and a salesman phone 119 comprises establishing a voice connection between the customer phone 107 connection and the salesman phone 119, selecting at least one product, by the customer using the customer phone 107 and delivering at least one of an invoice and a sales receipt, using at least one of a data connection and an SMS connection, by a sales management server 133, when a sales person using the salesman phone 119 needs to send an invoice or a sales receipt to the customer. It also comprises displaying, to the customer, the at least one of an invoice and a sales receipt using the customer phone 107 and soliciting a user response of the at least one of an invoice and a sales receipt. In addition, it comprises delivering the user response to the sales management server 145.

The delivering comprises determining the user response, digitally signing the user response to create a signature and transferring the user response and the signature to the sales management server. Delivering further comprises sending a user profile comprising a credit card account, a credit card expiry date, a billing address and a shipping address to the sales management server.

In addition, the method further comprises communicating a code by the sales person using the salesman phone to the customer and validating the at least one of an invoice and a sales receipt employing at least the code, prior to the displaying. The communication of the code may occur over a voice channel between the customer phone and the salesman phone.

In one embodiment of the present invention, a phone 107, is used for making purchases by a customer over a phone call. The phone 107 comprises a voice communication means to make the phone call to a salesperson on a second phone 119 and a data communication means for selectively receiving or retrieving an invoice from a remote merchant server 133 that creates the invoice. The phone 107 is capable of receiving and displaying a sales information wherein the sales information is at least one of an invoice and a sales receipt. The phone 107 receives the sales information from the remote merchant server 133, for review and approval, when the salesperson activates a sales information delivery function in the remote merchant server 133.

The phone retrieves the sales information from the remote merchant server 133, for review and approval, when the customer using the phone 107 activates a sales information retrieval function in the phone 107 during the time when the phone is simultaneously connected to the second phone 119 used by the salesperson. In a related embodiment, the remote merchant server 133 is a device management server that is based on a device management protocol.

The phone 107 may also comprise a user profile that is communicated to the remote merchant server 133 along with the user approval.

In general, the phone 107 further comprises a display means to display the sales information and an input means to receive a user approval for the displayed sales information. The phone 107 displays the sales information when it receives one, then solicits the user approval using the display means, and communicates the user approval to the remote merchant server 133 when the customer using the phone 107 responds to the solicitation of the user approval by using the input means. In one embodiment, the voice connection with the second phone 119 and the phone 107 and the data connection between the remote merchant server 133 and the phone 107 are simultaneously active.

The phone 107 provides the user with a code prompt to enter a code that is communicated by the salesperson using the second phone 119 to the customer using the phone 107. The phone 107 accepts the code provided by the customer in response to the code prompt displayed. The phone employs the code provided by the customer in response to the code prompt to validate the sales information presented by the remote merchant server 133.

The phone employs the code provided by the customer in response to the code prompt to validate the sales information presented by the remote merchant server. In addition, the phone employs a cryptographic key provided by a SmartCard 111 to digitally sign the user approval that is communicated to the remote merchant server. Also, the phone employs the voice connection circuitry to establish a voice connection with the second phone 119 used by the remote merchant, and the data communication circuitry to communicate with the remote merchant server 133 and to receive the sales information when the remote merchant causes the remote merchant server 133 to send the sales information.

In a related embodiment, the phone 107 retrieves the sales information from the remote merchant server 133, for review and approval, when the customer activates a sales information retrieval function in the phone during the time when the phone 107 is simultaneously connected to the second phone 119 used by the remote merchant over a voice channel.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method of conducting a sales transaction over a first phone connection established between a customer phone and a salesman phone, the method comprising:
collecting a sales information on at least one product selected by a customer;
communicating at least one of an invoice and a sales receipt, based on the collected information, by a sales management server to the customer phone;
receiving the at least one of an invoice and a sales receipt by the customer phone from the sales management server;
displaying the at least one of an invoice and a sales receipt by the customer phone;
soliciting customer approval for the at least one of an invoice and a sales receipt by the customer phone; and
communicating a customer response received to a sales management server by the customer phone.

2. The method according to claim 1, wherein collecting the sales information comprising:
entering, via a sales user interface associated with the sales management server, the sales information into the sales management server; and
storing the sales information.

3. The method according to claim 1, wherein the customer response is one of an approval and a rejection and wherein communicating comprising:
creating at least one of an invoice and a sales receipt based on the sales information;
establishing a second phone connection with the customer phone; and
transferring the at least one of an invoice and sales receipt to the customer phone over the second phone connection.

4. The method according to claim 3, wherein the first phone connection is a voice connection and the second phone connection is one of a SMS connection, a data connection, a data connection over GPRS, a data connection over VOIP, a data connection over EDGE, a data connection over WiFi, a data connection over WiMAX or a data connection over WAP.

5. A method of conducting a sales transaction using a customer phone and a salesman phone, the method comprising:
establishing a voice connection between the customer phone connection and the salesman phone;
selecting at least one product, by the customer using the customer phone;
delivering at least one of an invoice and a sales receipt, using at least one of a data connection and an SMS connection, by a sales management server, when a sales person using the salesman phone needs to send an invoice or a sales receipt to the customer;
displaying, to the customer, the at least one of an invoice and a sales receipt using the customer phone;
soliciting a user response of the at least one of an invoice and a sales receipt; and
delivering the user response to the sales management server.

6. The method of conducting a sales transaction according to claim 5 wherein the delivering comprising:
determining the user response;
digitally signing the user response to create a signature; and
transferring the user response and the signature to the sales management server.

7. The method of conducting a sales transaction according to claim 6 wherein the delivering further comprising:
sending a user profile comprising a credit card account, a credit card expiry date, a billing address and a shipping address to the sales management server.

8. The method of conducting a sales transaction according to claim 5, the method further comprising:
communicating a code by the sales person using the salesman phone to the customer; and
validating the at least one of an invoice and a sales receipt employing at least the code, prior to the displaying.

9. The method of conducting a sales transaction according to claim 5 wherein the communicating a code occurs over a voice channel between the customer phone and the salesman phone.

10. A phone for making purchases by a customer over a phone call, the phone comprising:
a voice communication means to make the phone call to a salesperson on a second phone;
a data communication means for selectively receiving or retrieving an invoice from a remote merchant server that creates the invoice;
the phone capable of receiving and displaying a sales information wherein the sales information is at least one of an invoice and a sales receipt.
the phone receiving the sales information from the remote merchant server, for review and approval, when the salesperson activates a sales information delivery function in the remote merchant server.

11. The phone of claim 10 wherein phone retrieves the sales information from the remote merchant server, for review and approval, when the customer using the phone activates a sales information retrieval function in the phone during the time when the phone is simultaneously connected to the second phone used by the salesperson.

12. The phone according to claim 11 wherein the remote merchant server is a device management server that is based on a device management protocol.

13. The phone according to claim 10, the phone further comprising:
a user profile that is communicated to the remote merchant server along with the user approval.

14. The phone of claim 10 wherein the phone further comprises:
a display means to display the sales information;
an input means to receive a user approval for the displayed sales information; and
the phone displaying the sales information when it receives one, then soliciting the user approval using the display means, and communicating the user approval to the remote merchant server when the customer using the phone responds to the solicitation of the user approval by using the input means.

15. The phone according to claim 14 wherein the voice connection with the second phone and the data connection with the remote merchant server are simultaneously active.

16. The phone according to claim 14 wherein the phone provides the user with a code prompt to enter a code that is communicated by the salesperson using the second phone to the customer using the phone and wherein the phone accepts the code provided by the customer in response to the code prompt displayed.

17. The phone according to claim 16 wherein the phone employs the code provided by the customer in response to the code prompt to validate the sales information presented by the remote merchant server.

18. The phone according to claim 17 wherein the phone employs the code provided by the customer in response to the code prompt to validate the sales information presented by the remote merchant server and wherein the phone employs a cryptographic key provided by a SmartCard to digitally sign the user approval that is communicated to the remote merchant server.

19. The phone according to claim 10 wherein the phone employs the voice connection circuitry to establish a voice connection with the second phone used by the remote merchant, and the data communication circuitry to communicate with the remote merchant server and to receive the sales information when the remote merchant causes the remote merchant server to send the sales information.

20. The phone according to claim 10 wherein the phone retrieves the sales information from the remote merchant server, for review and approval, when the customer activates a sales information retrieval function in the phone during the time when the phone is simultaneously connected to the second phone used by the remote merchant over a voice channel.
